(19) United States
(12) Patent Application Publication
(10) Pub. No.: US 2023/0407133 A1
(43) Pub. Date: Dec. 21, 2023

(54) CURABLE SILICONE COATING COMPRISING A NON-ORGANO TIN CATALYST

(71) Applicant: MOMENTIVE PERFORMANCE MATERIALS INC., Waterford, NY (US)

(72) Inventors: Masanori KIMURA, Gunma (JP); Adrian STEEDMAN, Hoogerheide (NL); Ramesh MUTHUSAMY, Bangalore (IN)

(21) Appl. No.: 18/265,106

(22) PCT Filed: Dec. 3, 2021
(86) PCT No.: PCT/US2021/061701

§ 371 Date: Jun. 2, 2023

(30) Foreign Application Priority Data
Dec. 6, 2020 (IN) 202021053086

(51) Int. Cl. C09D 183/08; C08G 77/12; C08G 77/16; C08G 77/26; C08G 77/28; C08G 77/08; C08K 3/04; C08J 7/04; C09D 5/02; C09D 7/20; C09D 7/63; C09D 7/61

(52) U.S. Cl. CPC C09D 183/08; C08G 77/12; C08G 77/16; C08G 77/26; C08G 77/28; C08G 77/08; C08J 2483/08; C08J 7/0427; C09D 5/021; C09D 7/20; C09D 7/63; C09D 7/61; C08J 2323/16; C08K 3/04

(57) ABSTRACT

A coating composition is shown and described herein. The coating composition is a solvent-based silicone coating comprising a tin-free catalyst. In embodiments, the composition comprises (a) a hydroxyl terminated polydiorganosiloxane; (b) an organopolysiloxane having at least two hydrogen atoms bonded to silicon atoms in the organopolysiloxane molecule; (c) a catalyst comprising a metal carboxylate, wherein the catalyst is free of tin; (d) a solvent; (e) optionally an amino compound; (f) optionally an adhesion promotor; and (g) optionally a filler.

### CROSS-REFERENCE TO RELATED APPLICATIONS

The present application claims priority to and the benefit of India Patent Registration Provisional Application No. 202021053086, titled “CURABLE SILICONE COATING COMPRISING A NON-ORGANO TIN CATALYST,” filed on Dec. 6, 2020, the disclosure of which is incorporated herein by reference in its entirety.

### FIELD OF INVENTION

The present invention relates to a solvent-based silicone coating composition and articles coated with the same. The compositions employ a catalyst that is free of tin. The compositions provide an alternative to tin-based compositions while providing a coating with excellent properties including, for example, abrasion resistance, and reduced surface friction.

### BACKGROUND

Various types of silicone based compositions have been used to treat substrate surfaces to impart various properties to the surface. Polyorganosiloxanes are used to treat surfaces such as rubber surfaces (e.g., ethylene-propylene-diene ternary copolymer (EPDM) rubber) to provide the surface with properties such as low (or even non) tackiness, water repellency, abrasion resistance, and lubricating properties. Such coatings may be employed in a variety of applications including, but not limited to, weather-strip applications. One issue that must be considered in the use of the silicone based coatings is providing a material that exhibits good adhesion to the substrate and film strength.

Tin based materials are widely used to promote condensation curing of silicone-based compositions. Dibutyltindilaurate (DBTDL) is popular due to its compatibility with a wide variety of additives in compositions and its catalytic activity in a variety of curing conditions. The use of tin based compounds, however, is becoming restricted due to their toxicity. While it may be beneficial to use non-tin materials to promote curing of the coating composition, tin-free catalysts may not be versatile enough to work in different formulations. The catalysts may not offer an alternative that still provides a composition with suitable adhesion along with desirable properties such as abrasion resistance, reduced friction and other surface modification.

### SUMMARY

The following presents a summary of this disclosure to provide a basic understanding of some aspects. This summary is intended to neither identify key or critical elements nor define any limitations of embodiments or claims. Furthermore, this summary may provide a simplified overview of some aspects that may be described in greater detail in other portions of this disclosure.

In one aspect, provided is a solvent based silicone coating composition employing a tin free catalyst. The present catalysts have been found to provide excellent curing and provide a coating with good adhesion and abrasion resistance.

In one aspect, provided is a curable silicone composition comprising: (a) a hydroxyl terminated polydiorganosiloxane; (b) an organopolysiloxane having at least two hydrogen atoms bonded to silicon atoms in the organopolysiloxane molecule; (c) a catalyst comprising a metal carboxylate, wherein the catalyst is free of tin; (d) a solvent; (e) optionally an amino compound; (f) optionally an adhesion promoter; and (g) optionally a filler.

In one embodiment, the metal carboxylate comprises a metal chosen from zinc, bismuth, titanium, or a mixture of two or more thereof.

In one embodiment, the metal carboxylate is a zinc carboxylate.

In one embodiment, the metal carboxylate is a titanate carboxylate.

In one embodiment, the metal carboxylate is a bismuth carboxylate.

In one embodiment, the metal carboxylate is chosen from zinc 2-ethylhexanoate, zinc neodecanoate, or a combination thereof.

In one embodiment in accordance with any of the previous embodiments, the amino compound (e) is chosen from an aliphatic amine, a cyclic amine, an amino alcohol, an aromatic amine, a β-aminocarbonyl compound, a β-aminonitrile compound, an aminosilicone compound, an aminosilane compound having a primary amino group or a combination of two or more thereof.

In one embodiment in accordance with any of the previous embodiments, the weight ratio of metal carboxylate in (c) to amino compound (e) is from 1:1 to about 8:1.

In one embodiment in accordance with any of the previous embodiments, the weight ratio of metal carboxylate in (c) to amino compound (e) is from 2:1 to about 7:1.

In one embodiment in accordance with any of the previous embodiments, the weight ratio of metal carboxylate in (c) to amino compound (e) is from 3:1 to about 5:1.

In one embodiment in accordance with any of the previous embodiments, the catalyst is provided in an amount of from about 0.005 (parts or wt. %) to about 10 (parts or wt. %); from about 0.01 (parts or wt. %) to about 8 (parts or wt. %); from about 0.1 (parts or wt. %) to about 5 (parts or wt. %); from about 0.5 (parts or wt. %) to about 5 (parts or wt. %); or from about 1 (parts or wt. %) to about 2.5 (parts or wt. %).

In one embodiment in accordance with any of the previous embodiments, the catalyst is provided in an amount of from about 0.005 (parts or wt. %) to about 0.5 (parts or wt. %); from about 0.01 (parts or wt. %) to about 0.4 (parts or wt. %); from about 0.05 (parts or wt. %) to about 0.3 (parts or wt. %); or from about 0.1 (parts or wt. %) to about 0.25 (parts or wt. %).

In one embodiment in accordance with any of the previous embodiments, the solvent is selected from a C1-6 alkanol, a C1-6 diol, a C1-10 alkyl ether of an alkylene glycol, a C3-24 alkylene glycol ether, a polyalkylene glycol, a C1-C6 carboxylic acid, a C1-C6 ester, an isoparaffinic hydrocarbon, mineral spirits, an alkylaromatic, a terpene, a terpenoid, formaldehyde, naphtha, an oil fraction, a pyrrolidone, or a combination of two or more thereof.

In one embodiment in accordance with any of the previous embodiments, the adhesion promoter is selected from an amino silane, an epoxy silane, a mercapto silane, an epoxy functional polydimethylsiloxane fluid, or an amino functional polydimethylsiloxane fluid, or a combination of two or more thereof.

In one embodiment in accordance with any of the previous embodiments, the filler (g) chosen from alumina, magnesia, ceria, hafnia, lanthanum oxide, neodymium oxide, samaria, praseodymium oxide, thoria, urania, yttria, zinc oxide, zirconia, silicon aluminum oxynitride, borosilicate glasses, barium titanate, silicon carbide, silica, boron carbide, titanium carbide, zirconium carbide, boron nitride, silicon nitride, aluminum nitride, titanium nitride, zirconium nitride, zirconium boride, titanium diboride, aluminum dodecaboride, barytes, barium sulfate, asbestos, barite, diatomite, feldspar, gypsum, hormite, kaolin, mica, nepheline syenite, perlite, phyrophyllite, smectite, talc, vermiculite, zeolite, calcite, calcium carbonate, wollastonite, calcium metasilicate, clay, aluminum silicate, talc, magnesium aluminum silicate, hydrated alumina, hydrated aluminum oxide, silica, silicon dioxide, titanium dioxide, glass fibers, glass flake, clays, exfoliated clays, or other high aspect ratio fibers, rods, or flakes, calcium carbonate, zinc oxide, magnesia, titania, calcium carbonate, talc, mica, wollastonite, graphite, expanded graphite, metallic powders, fibers or whiskers of carbon, graphite, nano-scale fibers, or a mixture of two or more thereof.

In another aspect, provided is an article comprising a body having a surface and a coating disposed on at least a portion of the surface, the coating being formed from a curable silicone composition in accordance with any of the previous aspects and embodiments.

In one embodiment, the body of the article is formed from paper, rubber, plastic or metal.

In one embodiment, the body of the article is formed from EPDM rubber.

In one embodiment, the article is in the form of an automobile weather-strip, a printer blade, a rubber vibration-isolator, or a gasket.

In another aspect, provided is a method of coating an article comprising: applying a curable silicone composition of any of claims 1-14 to a surface of a substrate; and curing the composition to form a coating.

In one embodiment, the curable aqueous silicone composition is cured at a temperature of from about 80 to 180° C.

In one embodiment, the curable aqueous silicone composition is applied by dip coating, spray coating, brush coating, knife coating or roll coating.

The following description discloses various illustrative aspects. Some improvements and novel aspects may be expressly identified, while others may be apparent from the description.

### DETAILED DESCRIPTION

Reference will now be made to exemplary embodiments, examples of which are illustrated in the accompanying drawings. It is to be understood that other embodiments may be utilized and structural and functional changes may be made. Moreover, features of the various embodiments may be combined or altered. As such, the following description is presented by way of illustration only and should not limit in any way the various alternatives and modifications that may be made to the illustrated embodiments. In this disclosure, numerous specific details provide a thorough understanding of the subject disclosure. It should be understood that aspects of this disclosure may be practiced with other embodiments not necessarily including all aspects described herein, etc.

As used herein, the words “example” and “exemplary” means an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

The present invention provides a solvent-based silicone coating composition. The composition may exhibit good adhesion to a substrate surface and good abrasion resistance. The composition employs a catalyst or cure promoter that is free of tin. In particular, the present composition provides a catalyst that is a mixture of a metal carboxylate and optionally an amino compound.

The coating compositions comprise: (a) a hydroxyl terminated polydiorganosiloxane; (b) an organopolysiloxane having at least two hydrogen atoms bonded to silicon atoms in the organopolysiloxane molecule; (c) a catalyst comprising a metal carboxylate; (d) a solvent; (e) optionally an amino compound as co-catalyst; (f) optionally an adhesion promotor; and (g) optionally a filler. The catalyst comprising the metal carboxylate and potentially the amino compound has been found to provide good curing along with good adhesion to a substrate and good abrasion resistance.

The hydroxyl terminated polydiorganosiloxane includes hydroxyl groups at the terminal ends of the polydiorganosiloxane that participate in the curing reaction. The organic radicals attached to the silicon atoms may be independently selected from an alkyl radical, an alkenyl radical, an aryl radical, an aralkyl radical, and a hydrocarbon radical having one or more hydrogen atoms replaced with a halogen atom, a nitril group, etc. Examples of suitable alkyl groups include, but are not limited to, C1-C10 alkyl radicals. In embodiments, the alkyl radical is chosen from methyl, ethyl, propyl, butyl, pentyl, and hexyl.

The hydroxyl terminated polydiorganosiloxane has a viscosity of 50 to mPa·s at 25° C.; 100 to 9,000,000 mPa·s at 25° C.; 250 to 8,000,000 mPa·s at 25° C.; 500 to 7,500,000 mPa·s at 25° C.; 1,000 to 5,000,000 mPa·s at 25° C.; 2,500 to 2,500,000 mPa·s at 25° C., etc. In embodiments, the hydroxyl terminated polydiroganosiloxane has a viscosity of 1,000 to 2,000,000 mPa·s at 25° C. Here as elsewhere in the specification and claims, numerical values may be combined to form new and non-specified ranges. Polydiorganosiloxanes with a viscosity below 50 mPa·s at 25° C. tend to be brittle upon curing. Polydiorganosiloxanes with a viscosity above 10,000,000 mPa·s at 25° C. increase the overall viscosity of the composition, which may cause the emulsions to be less stable and unpractical to work with. Viscosity is evaluated at 25° C. using a Hoeppler viscometer or a Brookfield viscosimeter (spindle LV 1-6 with 10 rpm).

The composition also includes a polyorganohydrogen siloxane (b). The polyorganohydrogen siloxane (b) is a organopolysiloxane having at least two hydrogen atoms bonded to silicon atoms in the organopolysiloxane molecule and undergoes dehydrogenative condensation with the terminal hydroxyl groups of the polydiorganosiloxane (a) to form a siloxane network. The organic group of the polyorganohydrogen siloxane (b) may be selected from the organic radicals discussed with respect to the polydiorganosiloxane (a). In embodiments, the polyorganohydrogen siloxane comprises methyl radicals. The polyorganohydrogen siloxane may be linear, branched, cyclic, or a mixture of two or more thereof. The polyorganohydrogen siloxane may have a viscosity of from about 1 to about 1000 mPa·s at 25° C.; from about 5 to about 300 mPa·s at 25° C.; or from about 10 to about 100 mPa·s at 25° C. Here, as elsewhere in the specification and claims, numerical values may be combined to form new and non-specified ranges. Viscosity is evaluated at 25° C. using a Hoeppler viscometer or a Brookfield viscosimeter (spindle LV 1-6 with 10 rpm).

The polyorganohydrogen siloxane can be provided in an amount of from about 0.5 to 20 parts by weight per 100 parts by weight of the polydiorganosiloxane (a). In embodiments, the polyorganohydrogen siloxane is provide in an amount of from about 1 to about 15 parts by weight per 100 parts by weight of the polydiorganosiloxane (a); from about 2.5 to about 12 parts by weight per 100 parts by weight of the polydiorganosiloxane (a); or from about 5 to about 10 parts by weight per 100 parts by weight of the polydiorganosiloxane (a). Here as elsewhere in the specification and claims, numerical values may be combined to form new and non-specified ranges.

The composition includes a curing catalyst (c). The catalyst (c) comprises a metal carboxylate. The metal carboxylate catalyst provides a composition that, upon curing, exhibits good adhesion and good abrasion resistance. In embodiments, the metal carboxylate includes a metal chosen from zinc, bismuth, and/or titanium.

In one embodiment, the carboxylate is a carboxylate derived from a monocarboxylic acid or a carboxylic acid anion containing at least two carbon atoms. In one embodiment, the metal carboxylate is derived from a carboxylic acid of the formula R¹COO⁻; wherein R¹ is a linear or branched C₁-C₃₀ alkyl group, a C₆-C₁₀ cyclic group, or a C₆-C₁₀ aromatic group. In one embodiment, IV is a linear or branched C₁₀-C₃₀ alkyl group. Non-limiting examples of suitable zinc compounds in the curing catalyst (c) include, but are not limited to, zinc 2-ethylhexanoate, zinc neodecanoate, zinc hexanoate, zinc stearate, zinc benzoate, zinc naphthenate, zinc laurate, or the like. Non-limiting examples of suitable bismuth compounds include bismuth acetate, bismuth oleate, bismuth octoate, or bismuth neodecanoate. Non-limiting examples of suitable titanium compounds include titanium tetra-n-decanoate; titanium tetra-n-undecanoate; titanium tetra-iso-butyrate; titanium tetra-2-ethyl-hexanoate; titanium tetra-2,2-dimethylpropanoate; titanium tetra-versatate; titanium tetra-3-ethyl-pentanoate; titanium tetra-citronellate; titanium tetra-naphthenate, or the like.

The composition optionally comprises an amine compound (e). While not being bound to any particular theory, the amine compound (e) may function as a co-catalyst with the metal carboxylate (c) to promote curing of the composition. In one embodiment, the amine compound (e) is chosen from a primary amine, a secondary amine, a substituted amine, or a combination of two or more thereof. In embodiments, the amine may be chosen from a linear or cyclic aliphatic amine, an aromatic amine, a heterocyclic amine, an amino ester compound, or a combination of two or more thereof. Non-limiting examples of suitable amines include an aliphatic amine, a cyclic amine, an amino alcohol, an aromatic amine, a β-aminocarobonyl compound, a β-aminonitrile compound, or a combination of two or more thereof. A primary amine and/or a secondary amine may refer to amine compounds comprising hydrocarbon groups, which may be saturated or unsaturated. The term “substituted amine” as used herein refers to an amine comprising a group other than a hydrocarbon group attached to the amine nitrogen or a hydrocarbon group that is attached to an amine nitrogen.

In one embodiment, the catalyst comprises an aliphatic amine selected from a linear, a branched, a cyclic, a saturated, an unsaturated, a polyfunctional amine, or a combination of two or more thereof. The amine may comprise one or more other functional groups as part of the compound.

In one embodiment, the catalyst comprises an aromatic amine where the amine functionality is directly attached to the aromatic ring, attached via spacers, incorporated into the ring, or a combination of two or more thereof.

In one embodiment, the amine compound comprises one or multiple amine functional group of the formula:

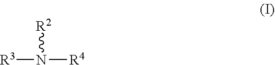

where formula (I) is a primary or secondary amine and R² is selected from hydrogen; a C₁-C₁₅ linear, branched, or cyclic alkyl group; a C₁-C₁₅ linear, branched, or cyclic alkyl group comprising one or more substituents chosen from a halide, N, O, or S; a C₆-C₁₀ aryl group; a C₇-C₁₆ linear or branched alkylaryl group; a C₂-C₄ polyalkylene ether; or a linear or branched C₇-C₁₆ heteroaralkyl, heteroalkyl, heterocycloalkyl, or heteroaryl; and where R³ and R⁴ are independently chosen from hydrogen; a C₁-C₁₅ linear, branched, or cyclic alkyl group; a C₁-C₁₅ linear, branched, or cyclic alkyl group comprising one or more substituents chosen from a halide, N, O, or S; a C₆-C₁₀ aryl group; a C₇-C₁₆ linear or branched alkylaryl group; a C₂-C₄ polyalkylene ether; a linear or branched C₇-C₁₆ heteroaralkyl; heteroalkyl, heterocycloalkyl, heteroaryl, with the provisos that (i) the compound of formula (I) is a primary or secondary amine, and (ii) the nitrogen atom is bi-substituted with either of R³, R⁴, or R³ and R⁴.

In one embodiment, the amino compound is chosen from an aliphatic amine, a cyclic amine, an amino alcohol, an aromatic amine, a β-aminocarobonyl compound, a β-aminonitrile compound, an aminosilicone compound, an aminosilane compound having a primary amino group or a combination of two or more thereof.

In one embodiment, the composition comprises an amine compound (e) that is a primary amine. Examples of suitable primary amines include, but are not limited to alkyl amines, substituted alkyl amines, cycloalkyl amines, aromatic amines, etc. Examples of suitable primary amines include, but are not limited to methylamine; ethylamine; n-propylamine; n-hexylamine; isopropylamine; t-octylamine; stearylamine; cyclohexylamine; 3-chloro-2-hydroxypropylamine; benzylamine; n-butylamine; s-butylamine; isobutylamine; t-butylamine; tris(hydroxymethyl)methylamine; ethanolamine; 3-hydroxy-2-methylpropylamine; isopropanolamine.

In one embodiment, the amine compound (e) is selected from dialkyl and substituted dialkyl amines, dimethylamine, diisopropylamine, dibutylamine, N-methylbutylamine, N,N-diallyl trimethylenediamine, diamylamine, dihexylamine, dioctylamine, N-ethylcetylamine, didodecylamine, ditetradecylamine, diricinoleylamine, N-isopropylstearylamine, N-isoamylhexylamine, N-ethyloctylamine, dioctadecylamine, their homologs and analogs, or a combination of two or more thereof.

In one embodiment, the amine compound (e) is selected from a secondary cycloalkylamine selected from dicyclohexylamine, N-methylcyclohexylamine, dicyclopentylamine, N-octylcyclohexylamine, N-octyl-3,5,5-trimethylcyclohexylamine, and their homologs and analogs; and unsaturated secondary amines, such as diallylamine, N-ethylallylamine, N-octylallylamine, dioleylamine, N-isopropylolelyamine, N-methyl-3,3,5-trimethyl-5-cyclohexenylamine, N-amyl-linoleylamine, N-methyl-propargylamine, diphenylamine, their analogs and homologs, or a combination of two or more thereof.

In one embodiment, the amine compound (e) is selected from an amino alcohol. The amino alcohol may be a primary or secondary amine. Examples of suitable amino alcohols include, but are not limited to, ethanol amine, 3-amino-1-propanol, 2-amino-1-propanol, 1-amino-2-propanol, 4-amino-1-butanol, 2-amino-1-butanol, 2-amino-2-methyl-1-propanol, 5-amino-1-pentanol, 2-amino-1-pentanol, 6-amino-2-methyl-2-heptanol, 1-amino-1-cycloheptane methanol, 2-aminocyclohexanol, 4-aminocyclohexanol, 1-aminomethyl-1-cyclohexanol, 2-(2-aminoethoxy)ethanol, 2-(methylamino)ethanol, 2-(ethylamino)ethanol, 2-(propylamino)ethanol, diethanolamine, diisopropanolamine, serinol, 2-amino-2-ethyl-1,3-propanol, 2-amino-2-methyl-1,3-propanol, 3-pyrrolidinol, 2-piperidine methanol, 2-piperidine ethanol, 3-hydroxypiperidine, 4-hydroxypiperidine, 4-aminophenetyl alcohol, 2-amino-m-cresol, 2-amino-o-cresol, 2-amino-p-cresol, 5-amino-2-methoxyphenol, 2-amino-4-chlorophenol, 4-amino-3-chlorophenol, 4-amino-2,5-dimethylphenol, tyramine, 2-amino-4-phenylphenol, 1-amino-2-napthanol, 4-amino-1-napthanol, 5-amino-1-napthanol, dopamine, etc.

In one embodiment, the amine compound (e) is selected from heterocyclic amine selected from piperidine, pyridine, methylpiperazine, 2,2,4,6-tetramethylpiperidine, 2,2,4,6-tetramethyl-tetrahydropyridine, N-ethyl 2,2,4,6 tetramethylpiperidine, 2-aminopyrimidine, 2-aminopyridine, 2-(dimethylamino)pyridine, 4-(dimethylamino)pyridine, 2-hydroxypyridine, imidazole, 2-ethyl-4-methylimidazole, morpholine, N-methylmorpholine, piperidine, 2-piperidinemethanol, 2-(2-piperidino)ethanol, piperidone, 1,2-dimethyl-1,4,5,6-tetrahydropyrimidine, aziridine, methoymethyldiphenylamine, nicotine, pentobarbital, or a combination of two or more thereof.

In one embodiment, the amine compound (e) is selected from diethanolamine, triethanolamine, N-methyl-1,3-propanediamine, N,N′-dimethyl-1,3-propnediamine, diethylenetriamine, triethylenetetramine, 2-(2-aminoethylamino)ethanol, 3-dimethylaminopropylamine, 3-diethylaminopropylamine, 3-dibutylaminopropylamine, 3-morpholinopropylamine, 2-(1-piperidinyl)ethylamine, and 2,4,6-tris(dimethylaminomethyl)phenol, or a combination of two or more thereof.

In the embodiment, the amine compound (e) is selected from aminosilicone or a silane compound having an amino group. In one embodiment, the aminosilicone can be a compound of the formula MDxD*yM, where M is (R⁵)(R⁶)(R⁷)SiO_{1/2}, D is (R⁸)(R⁹)SiO_{2/2}, and D* is (H₂N(CH₂)₂NH(CH₂)₃)(CH₃)SiO_{2/2}, where R⁵, R⁶, R⁷, R⁸, and R⁹ are independently selected from a C1-C30 monovalent hydrocarbon, x is 0-1000, and y is 1-200. In one embodiment, the aminosilicone is, for example, a polyorganosiloxane represented by an average formula: (CH₃)₃SiO[{H₂N(CH₂)₂NH(CH₂)₃}CH₃SiO]₁₀₀(CH₃)₃. The silane compound having an amino group is an alkoxysilane having a substituted or unsubstituted amino group bonded to a silicon atom via at least one carbon atom. Examples of the substituted or unsubstituted amino group include, but are not limited to, an aminomethyl group, a β-aminoethyl group, a γ-aminopropyl group, a δ-aminobutyl group, a γ-(methylamino)propyl group, a γ-(ethylamino)propyl group, an N-(β-aminoethyl)-γ-aminopropyl group, an N-(β-dimethylaminoethyl)-γ-aminopropyl group, and the like.

In one embodiment, the composition comprises both the metal carboxylate (c) and the amino compound (e). In embodiments, the metal carboxylate (c) and the amino compound (e) are provided in a weight ratio of about 1:1 to about 20:1; 1.5:1 to about 15:1; 2:1 to about 10:1; or about 3:1 to about 5:1.

The solvent (d) can be selected as desired for a particular purpose or intended application. Examples of suitable solvents include, alkanes, aromatic compounds, C1-6 alkanols, C1-6 diols, C1-10 alkyl ethers of alkylene glycols, C3-24 alkylene glycol ethers, polyalkylene glycols, short chain (C1-C6) carboxylic acids, short chain (C1-C6) esters, isoparafinic hydrocarbons, mineral spirits, alkylaromatics, terpenes, terpene derivatives, terpenoids, terpenoid derivatives, formaldehyde, naphtha, oil fractions, pyrrolidones, etc. Suitable alkanes include, but are not limited to, pentane, hexane, heptane, decane, dodecane, and the like. Suitable aromatic solvents include, but are not limited to benzene, toluene, xylene, and the like. Suitable alkanols include, but are not limited to, methanol, ethanol,-n-propanol, isopropanol, butanol, pentanol, and hexanol, and isomers thereof. Suitable diols include, but are not limited to: methylene, ethylene, propylene and butylene glycols. Examples of suitable alkylene glycol ethers include, but are not limited to, ethylene glycol monopropyl ether, ethylene glycol monobutyl ether, ethylene glycol monohexyl ether, diethylene glycol monopropyl ether, diethylene glycol monobutyl ether, diethylene glycol monohexyl ether, propylene glycol methyl ether, propylene glycol ethyl ether, propylene glycol n-propyl ether, propylene glycol monobutyl ether, propylene glycol t-butyl ether, di- or tri-polypropylene glycol methyl or ethyl or propyl or butyl ether, acetate and propionate esters of glycol ethers. Examples of suitable short chain carboxylic acids include, but are not limited to, acetic acid, glycolic acid, lactic acid and propionic acid. Examples of suitable short chain esters include, but are not limited to, glycol acetate, and cyclic or linear volatile methylsiloxanes.

The catalyst may be provided in an amount of from about 0.005 (parts or wt. %) to about 10 (parts or wt. %); from about 0.01 (parts or wt. %) to about 8 (parts or wt. %); from about 0.1 (parts or wt. %) to about 5 (parts or wt. %); from about 0.5 (parts or wt. %) to about (parts or wt. %); or from about 1 (parts or wt. %) to about 2.5 (parts or wt. %). In one embodiment, the catalyst is provided in an amount of from about 0.005 (parts or wt. %) to about 0.5 (parts or wt. %); from about 0.01 (parts or wt. %) to about 0.4 (parts or wt. %); from about 0.05 (parts or wt. %) to about 0.3 (parts or wt. %); or from about 0.1 (parts or wt. %) to about 0.25 (parts or wt. %). The wt. % is based on the total weight of the composition.

The composition may include other components as desired to provide additional benefits or properties to the coatings. In one embodiment, the composition comprises an adhesion promoter. Examples of suitable adhesion promoters include, but are not limited to, amino silanes, epoxy silanes, epoxy fluids, amino fluids, or the like.

The adhesion promoter can be selected as desired for a particular purpose or intended application. In one embodiment, the adhesion promoter is a silane based adhesion promoter. Examples of suitable adhesion promoters include, but are not limited to, amino silanes, epoxy silanes, mercapto silanes, epoxy fluids, amino fluids, etc., or combinations of two or more thereof.

In one embodiment, the adhesion promoter comprises or is selected from an amino silane. Examples of suitable amino silane adhesion promoters include, but are not limited to, gamma-aminopropyl triethoxysilane, gamma-aminopropyl trimethoxy silane, N-(beta-aminoethyl)-gamma-aminopropyl trimethoxy silane, triamino-organofunctional silanes, bis-[gamma-(trimethoxysily0propyl]amine, polyazamide silanes, N-(beta-aminoethyl)-gamma-aminpropyl methyldimethoxysilane, N-phenyl-gamma-aminopropyl trimethoxysilane, N-ethyl-gamma-aminoisobutyl trimethoxysilane, 4-amino-3,3-dimethylbutyl trimethoxysilane, 4-amino-3,3,-dimethylbutylmethyl trimethoxysilane, and 4-amino-3,3,-dimethylbutylmethyl dimethoxysilane. Some examples of suitable amino silanes include those available from Momentive Performance Materials Inc. under the tradenames Silquest™ A-1100™, A-1102, A-1106, A-1110, A-1120, A-1130, A-1170, A-1387, A-2120, A-9669, A-Link™ 15, A-1637, A-2639, and the like.

In one embodiment, the adhesion promoter is selected from an epoxy silane. Examples of suitable epoxy silanes include, but are not limited to, beta-(3,4-epoxycyclohexyl)ethyl trimethoxy silane, gamma-glycidoxypropyl trimethoxy silane, beta-(3,4-epoxycyclohexyl)-ethyl triethoxysilane, and gamma-glycidoxypropyl methyldiethoxysilane. Some examples of suitable epoxy silanes include, but are not limited to those available from Momentive Performance Inc. under the tradenames Silquest™ A-186, A-187™, Coatosil™ 1770, and Wetlink™ 78.

In one embodiment, the adhesion promoter is selected from a mercapto silane. Examples of suitable mercapto silanes include, but are not limited to, 3-mercaptopropyltrimethoxysilane, 3-mercaptopropyltriethoxysilane, 3-mercaptopropyl-methyl-dimethoxysilane, etc.

In one embodiment, the adhesion promoter can be selected from an epoxy fluid. Examples of suitable epoxy fluids include, and an epoxy modified siloxane of the formula Si(Me)₃O—(Si(Me)₂O)ₓ—(Si(Me)(R¹⁰)(O)_{y}—Si(Me)₃ where x is 0-1000, y is 1-100, and R¹⁰ is an epoxy functional group. In one embodiment, R⁵ is a glycidyloxy functional group and in embodiments

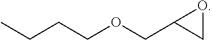

Examples of suitable materials for the adhesion promoter are di-Me, Me 3-(oxiranylmethoxy) propyl-siloxanes, gamma-Aminopropyltriethoxysilane, gamma-mercaptopropyltrimethoxysilane and mixtures thereof.

In one embodiment, the adhesion promoter can be selected from an amino fluid. Examples of suitable amino fluids include, but are not limited to, 3-aminopropyltriethoxysilane, an oligomer of 3-(2-aminoethylamino)propyltrimethoxysilane, a reaction product of 3-(2-aminoethylamino)propyltrimethoxysilane and 3-glycidyloxypropyltrimethoxysilane, etc.

The coating composition may be coated onto any suitable substrate. Examples of suitable substrates include, but are not limited to paper, rubber, plastic or metal. The composition may be coated using any suitable method such as, but not limited to, dip coating, spray coating, brush coating, knife coating or roll coating. Then, the coated substrate is left standing at room temperature for several hours or heated appropriately depending on the heat resistance of the substrate to cure the coated film. The heating conditions are preferably set to a temperature of 120 to 180° C. for 10 to 30 seconds for the paper substrate, a temperature of to 180° C. for 1 to 5 minutes for the rubber substrate, and a temperature of 70 to 150° C. for seconds to 2 minutes for the plastic substrate.

In order to improve the adhesiveness of the coating film with the substrate, various types of silane coupling agents may be added alone or as a mixture with or without partial condensation to the coating agent composition of the embodiment.

Other additives or materials may be added to the composition. Besides, accordingly an inorganic or organic ultraviolet absorber may be added for improvement of weatherability. A polydimethylsiloxane having a high viscosity may aid in lubricating properties. An organic or inorganic filler having an average particle diameter of 0.01 to 100 μm formed of polyalkyl silsesquioxane, polyolefin such as polyethylene, polycarbonate resin or the like may be added to provide a matte texture and improvement in lubricating properties. An inorganic pigment may be added for providing a desired color to the coating. If necessary, a thickener, an antifoaming agent and a preservative can be mixed appropriately.

The composition may also include a filler (g). The filler (g) is not particularly limited and may be selected as desired for a particular purpose or intended application. Examples of suitable fillers include, but are not limited to, polyolefin, polyurethane, alumina, magnesia, ceria, hafnia, lanthanum oxide, neodymium oxide, samaria, praseodymium oxide, thoria, urania, yttria, zinc oxide, zirconia, silicon aluminum oxynitride, borosilicate glasses, barium titanate, silicon carbide, silica, boron carbide, titanium carbide, zirconium carbide, boron nitride, silicon nitride, aluminum nitride, titanium nitride, zirconium nitride, zirconium boride, titanium diboride, aluminum dodecaboride, barytes, barium sulfate, asbestos, barite, diatomite, feldspar, gypsum, hormite, kaolin, mica, nepheline syenite, perlite, phyrophyllite, smectite, talc, vermiculite, zeolite, calcite, calcium carbonate, wollastonite, calcium metasilicate, clay, aluminum silicate, talc, magnesium aluminum silicate, hydrated alumina, hydrated aluminum oxide, silica, silicon dioxide, titanium dioxide, glass fibers, glass flake, clays, exfoliated clays, or other high aspect ratio fibers, rods, or flakes, calcium carbonate, zinc oxide, magnesia, titania, calcium carbonate, talc, mica, wollastonite, alumina, aluminum nitride, graphite, expanded graphite, metallic powders, e.g., aluminum, copper, bronze, brass, etc., fibers or whiskers of carbon, graphite, silicon carbide, silicon nitride, alumina, aluminum nitride, zinc oxide, nano-scale fibers such as carbon nanotubes, boron nitride nanosheets, zinc oxide nanotubes, etc., and mixtures of two or more thereof.

Still other fillers include spherical particles of rubber-like elastomer. The rubber-like elastomer forming the fine spherical particles is not limited to a particular type, but an elastic material having a value of hardness (rubber hardness) of less than 90, more preferably in a range of 60 to 80, measured according to JIS K 6253 is used. When fine particles of a hard or semihard material having hardness of 90 or more are used, the effects for prevention of creaking sound in the above-described water leaked state and prevention of damage to a coated metal surface cannot be obtained satisfactorily.

As the fine spherical particles of the rubber-like elastomer of the component (g), cross-linked urethane-based, cross-linked polymethyl methacrylate-based, cross-linked polyacrylic ester-based, cross-linked polybutyl methacrylate-based and silicone-based polymers are desirably used in view of the ease of availability and synthesis. And, such fine spherical particles have desirably an average particle diameter of about 0.1 to about 100 μm, and more preferably about 1 to about 20 μm. When the average particle diameter is less than 0.1 μm, the coating film has inferior lubricating properties, and when the average particle diameter exceeds 100 μm, the abrasion resistance becomes poor.

The blending amount of the fine spherical particles of the rubber-like elastomer (E) is about 10 to about 150 parts by weight, and more preferably about 30 to about 75 parts by weight, to 100 parts by weight of the hydroxyl terminated polydiorganosiloxane (a). The blending amount of the component (E) was limited to the above range because the coating film has poor lubricating properties when the blending amount is less than about 10 parts by weight, and because the coating property is degraded, the particles are aggregated and the coating film has a rough feeling when it exceeds 150 parts by weight.

The coating composition may be used to treat the surface of a substrate to provide a cured coating film having excellent adhesiveness and abrasion resistance to the substrate in comparison with a treatment by a conventional silicone composition can be obtained. In one embodiment, a coating film having outstanding adhesiveness and abrasion resistance can be formed on a rubber or plastic substrate, particularly a substrate formed of foamed or non foamed EPDM rubber, on which a coating film having sufficient adhesiveness could not be formed by using conventional silicone compositions for forming a non adhesive coating film.

The coating composition with the present catalyst system provides a cured coating film that can be formed at room temperature or a relatively low temperature. Therefore, the cured coating film, which can be formed on a substrate having a low heat resistance and a substrate which is large and hardly heat-treated, and has low or no tackiness to other substances, water repellency and outstanding abrasion resistance, is formed.

The coating agent composition of the present invention can be used suitably as a surface treatment agent for rubber parts such as automobile weather-strips, printer blades, rubber vibration-isolators, building material gaskets formed of EPDM rubber and so on. Besides, the coating agent composition of the present invention is used to provide various types of substrates of rubber, plastic and the like with low/non tackiness and good water repellency.

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

### EXAMPLES

### Evaluation of Non-Organotin Catalyst in Non-Aqueous Weatherstrip Coating Formulation

### Example 1-22: Evaluation of Diisopropoxy-Bisethylacetoacetatotitanate and K-KAT XK-661 (Zinc Carboxylate) as Catalyst (c)

A non-organotin catalyst, diisopropoxy-bisethylacetoacetatotitanate (Tyzor PITA), was tested in a non-aqueous weatherstrip coating formulation. 100 parts of Formulation 1 comprising 73% of xylene, 17% of a silanol stopped polydimethylsiloxane with a viscosity of 15 Pa·s, 8% of a methylsilsesquioxane spherical particle with a particle size of 5 micron, 1.5% of graphite, and 0.5% of carbon black was mixed with 4 parts of Formulation 2 comprising 10% of methylhydrogenpolysiloxane with a viscosity of 25 mPa·s in 90% of xylene. To this, adhesion promotor Formulation 3 comprising 70% isopropanol, 5% of gamma-mercaptopropyltrimethoxysilane, 15% of gamma-aminopropyltriethoxysilane and 10% of an epoxy functional polydimethylsiloxane with a molecular weight of 20,000 was added and mixed again. The titanate carboxylate, Tyzor PITA (100% actives), was employed as an example of a non-organotin catalyst in this formulation at various concentrations as examples Example 2-16. Tyzor PITA is commercially available in the market supplied by Dorf Ketal Specialty Catalyst Private Limited. A zinc carboxylate, K-KAT XK-661 (80% actives in n-Butyl acetate), was tested in this formulation at various concentrations as Examples 17-22. K-KAT XK-661 is available from King Industries. Formulations were spray coated on a pre-heated EPDM rubber substrate (80° C.) after storing them for 2 hours. Coated rubber substrates were cured for 10 minutes at 80° C. and the properties were tested after 24 hours. The test results were compared against Example 1, which is a standard formulation comprising an organotin catalyst of Formula 4 comprising 37% of dibutyltindiacetate in 63% of toluene as solvent.

The test results are summarized in Tables 1 and 2. Examples 2-6 were highly reactive and formed a gel within 180 minutes. Examples 1 and 7-14 were stable for 180 minutes and therefore tested for curability, abrasion resistance, surface finish and noise level upon rubbing. The Examples, as indicated in Table 1, were evaluated for their curing by lightly rubbing the coating with a cotton bud soaked in toluene. If the coatings are completely cured, it will not be removed with cotton bud and there will not be any black mark. Two pieces of coated rubber substrates were rubbed against each other and observed for the presence of scratches and squeaking noise generation. Similarly, the coated surface was rubbed against the wet glass sheet and listened for squeaking. Examples comprising optimized concentration of Tyzor PITA and K-KAT XK-661 showed similar properties as that of reference example 1 comprising the tin catalyst. The results show that non-organotin catalysts such as metal carboxylates, e.g., titanate carboxylate and zinc carboxylate, are suitable non-organotin catalyst for non-aqueous weatherstrip coating.

TABLE 1
Composition and properties of non-aqueous weatherstrip
coating Examples comprising Diisopropoxy-bisethylacetoacetatotitanate as a catalyst

| | Amounts in grams | | | | | | | |
|---|---|---|---|---|---|---|---|---|
| Composition | Ex1 | Ex2 | Ex3 | Ex4 | Ex5 | Ex 6 | Ex 7 | Ex8 |
| Hexane | 10 | 10 | 10 | 10 | 10 | 10 | 10 | 10 |
| Formulation 1 | 25 | 25 | 25 | 25 | 25 | 25 | 25 | 25 |
| Formulation 2 | 12.5 | 12.5 | 12.5 | 12.5 | 12.5 | 12.5 | 12.5 | 12.5 |
| Formulation 3 | 1.0 | 1.0 | 1.0 | 1.0 | 1.0 | 1.0 | 1.0 | 1.0 |
| Formulation 4 | 2.0 | | | | | | | |
| Tyzor PITA | | 0.04 | 0.073 | 0.135 | 0.270 | 0.540 | 0.050 | 0.100 |
| Mixed batch | | | | | | | | |
| stability | | | | | | | | |
| Stability T0 | ok | ok | ok | ok | ok | ok | ok | ok |
| Stability T30 | ok | ok | ok | Soft | Gelled | Gelled | ok | ok |
| | | | | gell | | | | |
| Stability T60 | ok | ok | Soft | Gelled | | | ok | ok |
| | | | gell | | | | | |
| Stability T120 | ok | ok | Gelled | | | | ok | ok |
| Stability T180 | ok | Soft gell | | | | | ok | ok |
| Sprayed after | ok | | | | | | ok | ok |
| T180 | | | | | | | | |
| Coating | | | | | | | | |
| properties | | | | | | | | |
| Appearance (*) | matt | | | | | | matt | matt |
| Cure (Tol rubs) | 10+ | | | | | | 10+ | 10+ |
| (** ) | | | | | | | | |
| Crock (900 gm) | 300 | | | | | | 280 | 260 |
| (***) | | | | | | | | |
| Gloss (60 deg) | 2.9 | | | | | | 3 | 2.8 |
| (****) | | | | | | | | |
| Noise (face/ | ok | | | | | | ok | ok |
| face) (*****) | | | | | | | | |
| Noise (wet | ok | | | | | | ok | ok |
| glass) (*****) | | | | | | | | |

Composition and properties of non-aqueous weatherstrip
coating Examples comprising Diisopropoxy-bisethylacetoacetatotitanate as a catalyst

| | Amounts in grams | | | | | | | |
|---|---|---|---|---|---|---|---|---|
| | Ex9 | Ex10 | Ex 11 | Ex12 | Ex13 | Ex 14 | Ex15 | Ex16 |
| Hexane | 10 | 10 | 10 | 10 | 10 | 10 | 10 | 10 |
| Formulation 1 | 25 | 25 | 25 | 25 | 25 | 25 | 25 | 25 |
| Formulation 2 | 12.5 | 12.5 | 12.5 | 12.5 | 12.5 | 12.5 | 12.5 | 12.5 |
| Formulation 3 | 1.0 | 1.0 | 1.0 | 1.0 | 1.0 | 1.0 | 1.0 | 1.0 |
| Formulation 4 | | | | | | | | |
| Tyzor PITA | 0.200 | 0.300 | 0.400 | 0.200 | 0.250 | 0.300 | 0.350 | 0.400 |
| Mixed batch | | | | | | | | |
| stability | | | | | | | | |
| Stability T0 | ok | ok | ok | ok | ok | ok | ok | ok |
| Stability T30 | ok | ok | ok | ok | ok | ok | ok | ok |
| Stability T60 | ok | ok | ok | ok | ok | ok | ok | ok |
| Stability T120 | ok | ok | ok | ok | ok | ok | Soft | Soft |
| | | | | | | | gell | gell |
| Stability T180 | ok | ok | ok | ok | ok | ok | Gelled | Gelled |
| Sprayed after | ok | ok | Sedimentation | ok | ok | ok | Gelled | Not |
| T180 | | | | | | | | possible |
| Coating | | | | | | | | |
| properties | | | | | | | | |
| Appearance (*) | matt | matt | matt | glossy | glossy | matt | matt | |
| Cure (Tol rubs) | 10+ | 10+ | 10+ | ok | ok | ok | ok | |
| (** ) | | | | | | | | |
| Crock (900 gm) | 280 | 250 | 220 | 310 | 300 | 360 | 370 | |
| (***) | | | | | | | | |
| Gloss (60 deg) | 3.2 | 2.9 | 3.1 | 5.8 | 4.4 | 3 | 2.3 | |
| (****) | | | | | | | | |
| Noise (face/ | ok | ok | ok | ok | ok | ok | ok | |
| face) (*****) | | | | | | | | |
| Noise (wet | ok | ok | ok | ok | ok | ok | ok | |
| glass) (*****) | | | | | | | | |

Experiment 2-11: Tyzor PITA diluted 10:1 in hexane; experiment 12-16: Tyzor PITA diluted 1:10 in hexane.
(*) Appearance is a visual comparison with a known standard.
(**) Cure test is done according ASTM-D4752
(***) Crockmeter is done according ISO 105 D02/SAE J861
(****) Gloss is done according ASTM-D523
(*****) Noise is comparative between the samples produced and a profile produced by customers on line with the reference coating described in Example 1.

TABLE 2
Composition and properties of non-aqueous weatherstrip coating
examples comprising K-KAT XK-661
(zinc carboxylate ) as a catalyst

| Composition | Ex17 | Ex 18 | Ex 19 | Ex 20 | Ex 21 | Ex 22 |
|---|---|---|---|---|---|---|
| Hexane | 10 g | 10 g | 10 g | 10 g | 10 g | 10 g |
| Formulation 1 | 25 g | 25 g | 25 g | 25 g | 25 g | 25 g |
| Formulation 2 | 12.5 g | 12.5 g | 12.5 g | 12.5 g | 12.5 g | 12.5 g |
| Formulation 3 | 1.0 g | 1.0 g | 1.0 g | 1.0 g | 1.0 g | 1.0 g |
| K-KAT XK-661 | 0.05 g | 0.10 g | 0.20 g | 0.30 g | 0.40 g | 0.70 g |
| Mixed bath | | | | | | |
| stability | | | | | | |
| Stability T0 | OK | OK | OK | OK | OK | OK |
| Stability T30 | OK | OK | OK | OK | OK | OK |
| Stability T60 | OK | OK | OK | OK | OK | OK |
| Stability T120 | OK | OK | OK | OK | OK | OK |
| Stability T180 | OK | OK | OK | OK | OK | OK |
| Sprayed after | OK | OK | OK | OK | OK | OK |
| T180 | | | | | | |
| Coating properties | | | | | | |
| Appearance | matt | matt | matt | matt | matt | matt |
| Cure(Tol rubs) (*) | OK | OK | OK | OK | OK | OK |
| Crock(900 g) (**) | 320 | 320 | 390 | 320 | 330 | 290 |
| Gloss(60 deg) | 2.9 | 3.0 | 3.0 | 3.2 | 3.2 | 3.1 |
| (***) | | | | | | |
| Noise(face/face) | OK | OK | OK | OK | OK | OK |
| (*****) | | | | | | |
| Noise(Wet glass) | OK | OK | OK | OK | OK | OK |
| (*****) | | | | | | |

K-KAT XK-661 diluted 1:10 in Hexane
(*) Appearance is a visual comparison with a known standard.
(**) Cure test is done according ASTM-D4752
(***) Crockmeter is done according ISO 105 D02/SAE J861
(****) Gloss is done according ASTM-D523
(*****) Noise is comparative between the samples produced and a profile produced by customers on line with the reference coating described in Example 1.

### Catalyst Nomenclature

(3) DCHA: Dicyclohexylamine
(4) HDDAc-2EHAm: 1,6Hexanedioldiacrylate—2Ethylhexylamine ((β-Aminoester)
(5) 2EHAc-BAm: 2Ethylhexylacrylate-Butylamine ((β-Aminoester)
(6) K-KAT XK-661: Zinc carboxylate-complex
(7) Tyzor PITA: Diisopropoxy-bisethylacetoacetatotitanate

The foregoing description identifies various, non-limiting embodiments of a coating composition. Modifications may occur to those skilled in the art and to those who may make and use the invention. The disclosed embodiments are merely for illustrative purposes and not intended to limit the scope of the invention or the subject matter set forth in the claims

1. A curable silicone composition comprising:
(a) a hydroxyl terminated polydiorganosiloxane;
(b) an organopolysiloxane having at least two hydrogen atoms bonded to silicon atoms in the organopolysiloxane molecule;
(c) a catalyst comprising a metal carboxylate, wherein the catalyst is free of tin;
(d) a solvent;
(e) optionally an amino compound;
(f) optionally an adhesion promoter; and
(g) optionally a filler.

2. The curable composition of claim 1, wherein the metal carboxylate comprises a metal chosen from zinc, bismuth, titanium, or a mixture of two or more thereof.

3. The curable composition of claim 1, wherein the metal carboxylate is a zinc carboxylate.

4. The curable composition of claim 1, wherein the metal carboxylate is a titanate carboxylate.

5. The curable composition of claim 1, wherein the metal carboxylate is a bismuth carboxylate.

6. The curable composition of claim 1, wherein the metal carboxylate is chosen from zinc 2-ethylhexanoate, zinc neodecanoate, or a combination thereof.

7. The curable composition of claim 1, wherein the amino compound (e) is chosen from an aliphatic amine, a cyclic amine, an amino alcohol, an aromatic amine, a β-aminocarbonyl compound, a β-aminonitrile compound, an aminosilicone compound, an aminosilane compound having a primary amino group or a combination of two or more thereof.

8. The curable composition of any of claim 1, wherein the weight ratio of metal carboxylate in (c) to amino compound (e) is from 1:1 to about 8:1.

9. The curable composition of claim 1, wherein the weight ratio of metal carboxylate in (c) to amino compound (e) is from 2:1 to about 7:1.

10. The curable composition of claim 1, wherein the weight ratio of metal carboxylate in (c) to amino compound (e) is from 3:1 to about 5:1.

11. The curable composition of claim 1, wherein the solvent is selected from a C1-6 alkanol, a C1-6 diol, a C1-10 alkyl ether of an alkylene glycol, a C3-24 alkylene glycol ether, a polyalkylene glycol, a C1-C6 carboxylic acid, a C1-C6 ester, an isoparaffinic hydrocarbon, mineral spirits, an alkylaromatic, a terpene, a terpenoid, formaldehyde, naphtha, an oil fraction, a pyrrolidone, or a combination of two or more thereof.

12. The curable composition of claim 1, wherein the adhesion promoter is selected from an amino silane, an epoxy silane, a mercapto silane, an epoxy functional polydimethylsiloxane fluid, or an amino functional polydimethylsiloxane fluid, or a combination of two or more thereof.

13. The curable composition of claim 1 comprising the filler (g) chosen from alumina, magnesia, ceria, hafnia, lanthanum oxide, neodymium oxide, samaria, praseodymium oxide, thoria, urania, yttria, zinc oxide, zirconia, silicon aluminum oxynitride, borosilicate glasses, barium titanate, silicon carbide, silica, boron carbide, titanium carbide, zirconium carbide, boron nitride, silicon nitride, aluminum nitride, titanium nitride, zirconium nitride, zirconium boride, titanium diboride, aluminum dodecaboride, barytes, barium sulfate, asbestos, barite, diatomite, feldspar, gypsum, hormite, kaolin, mica, nepheline syenite, perlite, phyrophyllite, smectite, talc, vermiculite, zeolite, calcite, calcium carbonate, wollastonite, calcium metasilicate, clay, aluminum silicate, talc, magnesium aluminum silicate, hydrated alumina, hydrated aluminum oxide, silica, silicon dioxide, titanium dioxide, glass fibers, glass flake, clays, exfoliated clays, or other high aspect ratio fibers, rods, or flakes, calcium carbonate, zinc oxide, magnesia, titania, calcium carbonate, talc, mica, wollastonite, graphite, expanded graphite, metallic powders, fibers or whiskers of carbon, graphite, nano-scale fibers, or a mixture of two or more thereof.

14. An article comprising a body having a surface and a coating disposed on at least a portion of the surface, the coating being formed from a curable silicone composition of claim 1.

15. The article of claim 14, wherein the body of the article is formed from paper, rubber, plastic or metal.

16. The article of claim 14, wherein the body of the article is formed from EPDM rubber.

17. The article of claim 14, wherein the article is in the form of an automobile weather-strip, a printer blade, a rubber vibration-isolator, or a gasket.

18. A method of coating an article comprising:
applying a curable silicone composition of claim 1 to a surface of a substrate; and curing the composition to form a coating.

19. The method of claim 18, wherein the curable aqueous silicone composition is cured at a temperature of from about 80 to 180° C.

14. The method of claim 18, wherein the curable aqueous silicone composition is applied by dip coating, spray coating, brush coating, knife coating or roll coating.
